(19) United States
(12) Patent Application Publication
(10) Pub. No.: US 2022/0042769 A1
(43) Pub. Date: Feb. 10, 2022

(54) AUTONOMOUS OPTRONIC MODULE FOR GEOLOCATED TARGET POINTING FOR A PORTABLE SYSTEM, AND CORRESPONDING SYSTEM

(71) Applicant: IXBLUE, Saint-Germain-en-Laye (FR)

(72) Inventor: Bruno CREPY, Saint-Germain-en-Laye (FR)

(21) Appl. No.: 17/297,668

(22) PCT Filed: Nov. 28, 2019
(86) PCT No.: PCT/EP2019/082992

§ 371 Date: May 27, 2021

(30) Foreign Application Priority Data
Nov. 29, 2018 (FR) 1872006

(51) Int. Cl. F41G 3/06; F41G 1/32; G06K 9/00

(52) U.S. Cl. CPC F41G 3/065; G06K 9/0063; F41G 1/32

(57) ABSTRACT

Disclosed is an autonomous visual pointing module producing location information about a target aimed at by a user and intended to be installed on portable equipment to form a portable and autonomous visual target pointing system, the target location information being at least the target heading. The module includes: —an autonomous power supply, —control, calculation and user-interfacing electronic circuits, —a motion sensor including an inertial navigation system, INS, or an attitude heading reference system, AHRS, including gyrometers and accelerometers, —a satellite geolocation receiver, GNSS, for providing the module location in real type and continuously, —an optronic unit including a set of optical sensors of the viewfinder and/or camera type, for visually pointing the module to the aimed-at target, and a rangefinder for determining the distance between the target and the module. The gyrometers are of the fibre-optic type.

### CROSS-REFERENCE TO RELATED APPLICATIONS

This application is the U.S. national phase of International Application No. PCT/EP2019/082992 filed Nov. 28, 2019 which designated the U.S. and claims priority to FR 1872006 filed Nov. 29, 2018, the entire contents of each of which are hereby incorporated by reference.

### BACKGROUND OF THE INVENTION

### Field of the Invention

The present invention generally relates to the field of optronic devices for measuring target location and/or heading by pointing. It more particularly relates to an autonomous visual pointing module referenced with motion sensors of the Inertial System (INS) or Attitude Heading Reference System (AHRS) type and a satellite geolocation receiver, the module being intended to be installed on equipment to form a portable visual target pointing system. The module, which is compact and light-weight, can be preinstalled on the equipment. The module can also be in the form of a “kit” that can be fitted on the equipment.

### Description of the Related Art

There exists a need, in particular in a defence and security context, to point a target in order to acquire one or several pieces of information about the absolute and/or relative location of said target.

Several pointing systems currently exist on the market:
Systems consisted of cameras and Northfinder arranged on a fine pointing device installed on a tripod support. These systems allow the long-distance target acquisition but are generally heavy and require above all a prior installation because they have to be mounted on a tripod support, which takes some time.
Equipment consisted of cameras in the form of a handgun, which allows an instantaneous operation but which require regular relocating in a calibration unit such as, for example, the IPD system of SOFRESUD.

Documents FR3057656 A1, FR2942044 A1, FR2929700 A1, FR2758625 A1, FR2852405 A1 and CA2249474 A1 or also FR2824132 A1 are known, which disclose systems of this field.

Documents U.S. Pat. No. 8,275,544 B1, US2018/224244 A1, US2012/059575 A1, WO2007/028826 A1 and U.S. Pat. No. 4,949,089 A are also known.

These devices available on the market do not allow to benefit simultaneously from the following characteristics:
light-weight with a mass of less than five kilograms for the pointing means,
a navigation autonomy of several hours without intervention or necessity of recalibration,
an immediate operational availability thanks to the “shoulder-strap” portability of the system.

### SUMMARY OF THE INVENTION

In order to remedy the above-mentioned drawbacks of the state of the art, the present invention proposes to implement, within a portable and autonomous system for the visual pointing of a target, a module including a motion sensor, in particular an inertial navigation system (INS) or an attitude heading reference system (AHRS), which are capable of autonomously determining the North direction, a satellite geolocation receiver, and which are coupled to a viewing unit.

More particularly, it is first proposed according to the invention an autonomous visual pointing module producing location information about a target aimed at by a user and intended to be installed on portable equipment to form a portable and autonomous visual target pointing system, the target location information being at least the target heading.

According to the invention, the module includes:
an autonomous power supply,
control, calculation and interfacing electronic circuits,
a motion sensor including an inertial navigation system, INS, or an attitude heading reference system, AHRS, including gyrometers and accelerometers,
a satellite geolocation receiver, GNSS, for providing receiver location data in real time and continuously, the control, calculation and interfacing electronic circuits being configured to allow a hybridization of the satellite geolocation receiver with the motion sensor, so that at least the motion sensor can substitute for the satellite geolocation receiver in case where the latter could not provide location data,
an optronic unit including a set of optical sensors of the viewfinder and/or camera type, for visually pointing the module to the aimed-at target, and a rangefinder for determining the distance between the target and the module.

In this document, the terms “direction” and “heading” relating to the target are considered as synonymous.

Other non-limitative and advantageous features of the module according to the invention, taken individually or according to all the technically possible combinations, are the following:
the interfacing is made in particular with the user,
the control, calculation and interfacing electronic circuits are configured to allow a hybridization of the a satellite geolocation receiver with the motion sensor, so that the a satellite geolocation receiver can further correct the potential drifts of the motion sensor,
the target location information is absolute or relative, in particular as a function of the nature of the sensors implemented and/or of calculations performed in the control, calculation and interfacing electronic circuits,
the target location information is related to the module,
the target location information is selected among one or several of the following: the target heading, the target distance, the target coordinates, the module coordinates,
the target location information is at the same time the target heading and the target distance and the target coordinates and the module coordinates,
the module further produces module location information, including in particular the module coordinates,
the location information about the target aimed at by the user are calculated as a function of the detection by the module of at least one determined condition,
the determined conditions are chosen among: an action by the user, in particular pressure on a calculation control push-button, immobilization of the module, reduction of the module displacement speed, measurement by the rangefinder of a distance lower than or equal to a determined value, shape recognition in camera(s) images . . .
the location information about the target aimed at by the user are calculated on demand, the user having to perform an action to obtain the aimed-at target location information,
the motion sensor is “gyrocompassing”, that is to say that it is capable of autonomously determining the North direction,
the North is the geographic North,
the inertial navigation system is “gyrocompassing”, that is to say that it is capable of autonomously determining the North direction,
the attitude heading reference system is “gyrocompassing”, that is to say that is capable of autonomously determining the North direction,
the motion sensor includes three non-coplanar gyrometers and, further, three non-coplanar accelerometers,
the gyrometer-based motion sensor includes gyrometers of the fibre-optic, FOG, or ring-laser, RLG, or hemispherical-resonator, HRG, type, or any other gyrocompassing technology, that is to say capable of autonomously determining the North direction,
the motion sensor is chosen among the inertial navigation systems, INS, or the attitude heading reference systems, AHRS, which may be of the FOG (fibre-optic gyroscope) or RLG (ring-laser gyroscope) or HRG (hemispherical-resonator gyroscope) type, or any other gyrocompassing technology, that is to say capable of autonomously determining the North direction,
the inertial navigation system, INS, is hybridized with the satellite geolocation receiver, GNSS, in particular of the GPS type,
the control, calculation and interfacing electronic circuits include at least one Kalman filter forming a dynamic positioning filter,
the inertial navigation system, INS, includes at least one Kalman filter forming a dynamic positioning filter,
the attitude heading reference system, AHRS, includes at least one Kalman filter forming a dynamic positioning filter,
the dynamic positioning filter of the inertial navigation system, INS, uses, on the one hand, the gyrometer and accelerometer measurements/observations to calculate the module heading and location and, on the other hand, location data about the receiver GNSS, in order to limit the error propagation when integrating the accelerometer measurements/observations, said integration of the accelerometer measurements/observations being a double integration, and/or when integrating the gyrometer measurements/observations, said integration of the gyrometer measurements/observations being a simple integration,
the inertial navigation system, INS, is further hybridized with a pedometer in order to limit the module location drift in case of absence of reception of signals from the satellite geolocation receiver, GNSS,
the attitude heading reference system, AHRS, is further hybridized with a pedometer in order to limit the module location drift in case of absence of reception of signals from the satellite geolocation receiver, GNSS,
the pedometer provides the motion sensor with module displacement speed data that are used by the Kalman filter of the inertial navigation system, INS, or the attitude heading reference system, AHRS, to limit the drifts of the motion sensor,
the module further includes an attachment device for attaching the module to the portable equipment and the attachment device is configured to be attached to an attachment rail of the equipment,
the attachment rail of the equipment is a Picatinny rail that meets the rail standards MIL-STD-1913 or STANAG 2324,
the rangefinder is chosen among fibre-laser rangefinders, diode-laser rangefinders or solid-laser rangefinders,
the optronic unit includes one or several of the following elements:
   a “direct-optical” viewfinder,
   a visible-sensitive camera,
   an intensified camera,
   a specifically infrared-sensitive camera,
   a rangefinder,
   a laser rangefinder,
   a laser pointer,
the viewfinder optical sensors are user direct-sight,
the camera optical sensors produce images,
the images of the camera optical sensors are displayed on at least one viewer,
the module includes a user direct-sight optical viewfinder or at least one target viewing camera producing images, said at least one camera allowing viewing the target at least in daylight,
the at least one camera further allows viewing the target by night,
the module includes:
either two cameras, a first one for viewing the target in daylight and a second one for viewing the target by night, the second camera being chosen among the light-intensifying camera or the only infrared-sensitive cameras,
or a single camera for viewing the target in daylight combined with a target illuminator for lighting the target by night in order to allow its viewing,
or a single, only infrared-sensitive camera for viewing the target both in daylight and by night,
the target illuminator is chosen among the light-emitting diodes and the laser diodes,
the target illuminator illuminates the target in the visible for the human eye,
the target illuminator illuminates the target in the infrared, not visible for the human eye,
the module and the electronic circuits of the module are configured to calculate at least one piece of information about the location of the aimed-at target, chosen among: the target heading/direction, the target distance and target location coordinates,
the viewer is incorporated to the module,
the viewer is arranged remote from the module, the transmission of the images between the module and the viewer being wired or wireless,
the module includes at least one viewer integrated to the module and/or arranged remote from the module,
the module includes at least one camera producing images of the aimed-at target and at least one viewer for displaying said images, said at least one viewer being integrated to the module and/or arranged remote from the module,
the viewer allows rendering the images taken by the sensors,
said at least one viewer further allows displaying the aimed-at target location coordinates,
the viewer allows indicating at least one piece of information about the absolute location of the aimed-at target,
the viewer allows indicating at least one piece of information about the relative location of the aimed-at target,
the viewer allows indicating at least one piece of information about the location of the aimed-at target,
the viewer allows indicating at least the heading of the aimed-at target,
the viewer allows indicating at least the heading and the distance of the aimed-at target,
the viewer further allows indicating the target location coordinates, knowing the module location and the measurement of the target distance with respect to the module by the rangefinder,
the module includes a sound interface for generating audible messages providing one or several pieces of information about the target,
the audible messages are delivered by a loudspeaker of the module,
the audible messages are delivered by a headset connected to the module by a wire connection,
the audible messages are delivered by a headset connected to the module by a short-range wireless connection,
the module includes a wireless data communication device for transmitting the target location information and the images of the aimed-at target in the case where the module includes at least one camera,
the wireless data communication device is short-range,
the wireless data communication device is long-range,
the wireless data communication device is on a data communication network, in particular a wireless telephone network,
the viewer arranged remote from the module is carried by the user as a viewfinder,
the viewer arranged remote from the module is a head-up display viewer, in particular in the form of a pair of glasses or a helmet visor,
the viewer allows displaying one or several of the following: images of the aimed-at target, heading of the aimed-at target, module location coordinates, target location coordinates, distance from the target to the module, other pieces of information,
the module includes a wired communication device for at least transmitting images of the target to a viewer remote from the module and carried by the user,
the module includes a short-range wireless communication device for at least transmitting images of the target to a viewer remote from the module and carried by the user,
the viewer remote from the module and carried by the user is a head-up display viewer, in particular in the form of a pair of glasses or a helmet visor,
the module has a level of uncertainty that is lower than or equal to 2 mrad rms for the target direction/heading in case of use of an inertial navigation system with fibre-optic gyrometers with coils of 50 mm and a level of accuracy for the location corresponding to that of the satellite geolocation receiver, GNSS,
the module has a level of uncertainty on the distance to the aimed-at target that is lower than or equal to 1 m for a target located at a maximum distance of 5 km,
the module has a level of uncertainty on the absolute location coordinates of the aimed-at target that is lower than or equal to 10 m for a target located at a maximum distance of 2 km,
the module has a level of uncertainty on the relative location coordinates of the aimed-at target with respect to the module that is lower than or equal to 5 m for a target located at a maximum distance of 2 km,
the optronic unit is referenced by the inertial navigation system, INS, or the attitude heading reference system, AHRS, in such a way that, at the time of pointing to the target, the motion sensors allow calculating in the calculation electronic circuits at least the heading/direction of the aimed-at target,
the module that allows obtaining only the target direction/heading includes an attitude heading reference system, AHRS,
the module that allows obtaining only the target direction/heading and distance includes an attitude heading reference system, AHRS, and a rangefinder,
the optronic unit is referenced at least by the inertial navigation system, INS, or by the attitude heading reference system, AHRS, and the rangefinder, in such a way that, at the time of pointing to the target, the motion sensors allow calculating in the calculation electronic circuits at least the target direction/heading and the target location, said systems having been previously/preliminarily relocated,
the module that allows obtaining at least the target direction/heading and the target location includes a satellite geolocation receiver, GNSS, an attitude heading reference system, AHRS, and a rangefinder,
the module that allows obtaining at least the target direction/heading and the target location with an ability to evolve in an environment in which the reception of the satellite signal by the satellite geolocation receiver, GNSS, is not possible (“GNSS denied”), includes an inertial navigation system, INS, a satellite geolocation receiver, GNSS, and a rangefinder,
the module that allows obtaining at least the target direction/heading and the target location with an ability to evolve in an environment in which the reception of the satellite signal by the satellite geolocation receiver, GNSS, is not possible (“GNSS denied”), includes an inertial navigation system, INS, and a rangefinder, the motion sensor requiring a previous relocation,
the module is configured in such a way that the relocation of the motion sensor is performed with a satellite geolocation receiver, GNSS, that is external to and distinct from the module, in particular a satellite geolocation receiver, GNSS, of a vehicle,
the module is configured in such a way that the relocation of the motion sensor is performed directly with the module thanks to angular or triangulation measurements of several visible points of reference of the optronic unit and having known locations,
the module has a level of uncertainty lower than or equal to 2 mrad rms for the heading when the inertial navigation system is of the FOG (Fibre-Optic Gyrometer) type, with coils of optical fibres of 50 mm, and a level of accuracy for the location corresponding to that of the satellite geolocation receiver, GNSS,
the module is configured to allow the relocation of the motion sensor by angular or triangulation measurements, of several points of reference visible by the optronic unit and having known locations, said reference points being in particular landmarks, buildings, stars in the sky . . . of known locations,
the relocation of the motion sensor by angular or triangulation measurements is performed in the absence of satellite geolocation receiver, GNSS, in the module or in case of unavailability of said receiver present in the module,
the module is compact,
the module occupies a volume lower than 20 000 cm3,
the module occupies a volume greater than 1 000 cm3,
the module has the following typical size: 35 cm×25 cm×12 cm,
the module has a weight lower than 5 kg,
the module has a weight higher than 1 000 g,
the module is configured in such a way as to allow a quick pointing sight, of the order of a fraction d of one second, to obtain the target location information,
the module is configured as a viewfinder,
the module is configured as a rifle or has the appearance of a handgun,
the module can be assembled and rigidly attached to a piece of equipment or a weapon,
the equipment is a portable weapon,
the portable weapon is a projectile weapon,
the portable weapon is firearm,
the portable weapon is an electromagnetic radiation generator,
the portable weapon is a laser beam generator.

The invention also relates to a system consisted of an autonomous visual pointing module attached to portable equipment, which module is in accordance with the described invention and the portable equipment is a portable weapon, said portable weapon being intended to at least remotely neutralize a targeted objective.

Thanks to the use of a navigation system, the autonomous portable system makes it possible to determine the target heading and, in evolved versions, the location coordinates thereof in a very reduced time, typically within less than a fraction of a second. This also allows performing a navigation/displacement with the system during several hours without needing to frequently relocate/recalibrate it on a dedicated station in the case where the module has no satellite geolocation receiver, GNSS. Preferably, the motion sensor has no part in motion in the gyrometers because the latter are of the fibre-optic type, and the system can hence be “hardened” and made “all terrain”. If the system/module is used in a purely inertial mode, whether because the module has no satellite geolocation receiver, GNSS, or if one is included, because the signals thereof are unavailable, then it is necessary to regularly perform relocation/recalibration in order to restore the heading performances of the inertial navigation system, INS, or of the attitude heading reference system, AHRS.

The invention can be in several forms, including a module attached to a rifle or a pistol or a machine gun, by means of a Picatinny rail for example, or have already been integrated to a rifle or a pistol to facilitate its handling. In a variant, the module is installed on equipment that is not a weapon. In particular, the module can be installed on equipment that is simply a module support and that may serve to aim at a target, and has the general form of a rifle or equivalent or a pistol or equivalent. The system consisted of the module and the equipment can thus have other functions than simply producing location information about the aimed-at target, and in particular making it possible to shoot projectiles in case of firearm-type equipment. The module, due to the possibility of remote transmission of the information about the target absolute or relative location, can serve to control the orientation of the devices located remote from the module. For example, a cameraman can film the departure of a target rocket with a camera including the module and the module can transmit the rocket location to other cameras orienting automatically to the rocket and that are at other places to observe the rocket according to various angles.

### BRIEF DESCRIPTION OF THE DRAWINGS

FIG. 1 is a schematic illustration of a first example of module according to the invention, including a means for the removable attachment to an assault rifle,

FIG. 2 is a schematic illustration of a second example of module according to the invention, including a means for the removable attachment to an assault rifle,

FIG. 3 shows the application of a module according to the invention in a dedicated system in the form of a rifle,

FIG. 4 is a generic schematic illustration of the interconnections between the different main elements of the module, and

FIG. 5 shows a module according to the invention in the form of a viewfinder that can be attached to a rifle.

### DESCRIPTION OF THE PREFERRED EMBODIMENTS

The following description in relation with the appended drawings, given by way of non-limitative examples, will allow a good understanding of what the invention consists of and of how it can be implemented.

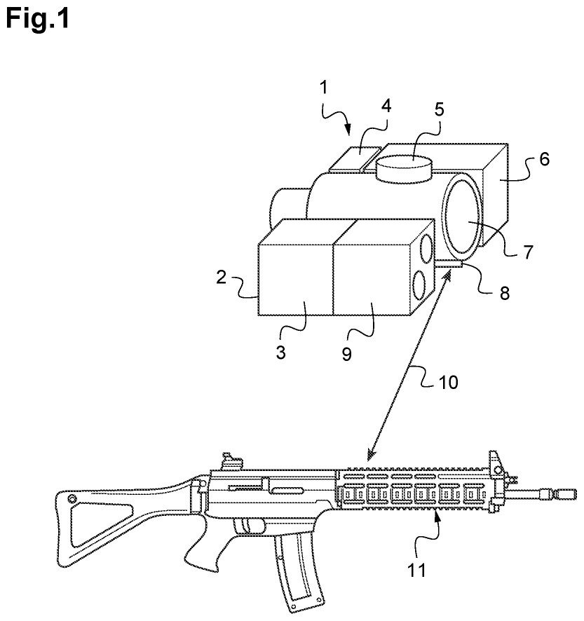

In the first example of FIG. 1, the pointing module 1 is provided with a quick attachment device 8 for a quick and accurate mounting on portable equipment that is here an assault rifle 11, the mounting being symbolized by the arrow 10 between the module 1 and an assault rifle 11. This attachment device 8 is compatible with a rail of the Picatinny rail type. The attachment device 8 hence allows a quick and accurate attachment of the module on a weapon or on any other equipment pre-fitted with a Picatinny rail or that will have been fitted with such a rail for the attachment of the module. The attachment device 8 can further include mechanical adjustment means so that the module sight allows using the module as the own sighting means of the weapon or equivalent.

The rechargeable battery 3 powers the module 1 in such a way as to make it energetically self-sufficient. The camera 7, here of the infrared type, makes it possible to view the target and its environment both in daylight and by night. A crosshair allows defining a reference line of sight of the target in the field of observation of the camera 7. The infrared camera 7 can be cooled or non-cooled. The infrared camera 7 can allow an observation in the SWIR, MWIR and/or LWIR bands.

The module 1 includes an inertial navigation system, INS, 6 hybridized with a satellite geolocation receiver, GNSS, 5, which allow, in electronic circuits forming a calculator 4, to permanently calculate the location of the module 1 and the target direction or heading. The satellite geolocation receiver 5 may be of the GPS type.

The inertial navigation system, INS, includes internal calculation means, in particular with a Kalman filter, and means for data exchange with other sensors and, in particular, for receiving location data produced by the satellite geolocation receiver, GNSS, 5. Due to the combination of the data from the inertial navigation system, INS, 6 and from the satellite geolocation receiver, GNSS, 5, as well as other data from other sensors (for example, a pedometer, accelerometers . . . ) and to the use of a Kalman filter, the calculated location information remain optimum for almost all the operation conditions met, for example, in case of GSNN signal loss, it is possible to continue obtaining location information even if they are less accurate than if all the sensors were still working.

The inertial system that is implemented, preferably of the FOG type, has a size lower than 100 mm×100 mm×100 mm and the optical fibre loops have diameters of 50 mm or less. This inertial system is hybridized with a satellite geolocation receiver or “Global Navigation Satellite System” (GNSS). The inertial system has a level of uncertainty lower than or equal to 2 mrad rms for the heading and, for the location, a level of accuracy corresponding to that of the satellite geolocation receiver.

If the signal of the satellite geolocation receiver 5 is received nominally, the location of the module 1 is known with an accuracy of less than 5 m. With an inertial navigation system, INS, 6 of the FOG type, based on an optical fibre coil of 50 mm diameter, the heading is known with an accuracy better than 2 mils. In case of loss of the satellite geolocation receiver 5 signal and in a “purely inertial” mode, the operator heading and location values provided by the module 1 will be all the more degraded since the signal loss duration is long and since the module 1 has been moved during this time.

The module 1 also includes a laser rangefinder 9 that, when it is activated towards the target, allows determining the module-target distance. There hence exists in this exemplary embodiment a means for activating the rangefinder 9.

A calculator 4 operates to calculate information about the target absolute or relative location, which can be provided to the operator, including the target location coordinates, from module location, target heading and target distance data.

The module implements at least one Kalman filter to process the data coming from the various sensors (gyrometers, accelerometers, satellite geolocation receiver, pedometer . . . ) available in the considered version of the module (of the INS or AHRS type, with or without a satellite geolocation receiver, with or without a pedometer . . . ). The Kalman filter may be implemented in the inertial navigation system, INS, or in the attitude heading reference system, AHRS, and/or, in the calculation means of the control, calculation and interfacing electronic circuits, these latter being connected to the various sensors of the module to recover therefrom the produced data and to process these data.

Hence, for example, the implementation of a Kalman filter in the inertial navigation system, INS, allows mutualizing the advantages of the INS system and of the GNSS receiver: the possible slow drift of the INS system can be corrected by the GNSS receiver data and, in case of loss of the GNSS receiver data, the location information can continue to be calculated thanks to the only INS system. By way of illustration, if the GNSS receiver data are of good quality, it will be mainly the GNSS receiver data that will be used to determine the location information. If the GNSS receiver data become unavailable, the INS system operates to continue providing location information whose quality will deteriorate over the duration of the GNSS data flow loss. In this example, the location information may be absolute and continue to be absolute despite the GNSS data flow loss.

On the other hand, in the case where the motion sensor is an attitude heading reference system, AHRS, the correct reception of the GNSS data is indispensable to obtain absolute location information because these latter are produced only by the GNSS receiver, the AHRS system being unable to substitute for it. However, in case of GNSS data flow loss, the module can be used to provide the heading thanks to the AHRS system and the distance to the target if the rangefinder is installed in the module. In this latter case, the target location information is relative and is hence provided with reference/respect to the module. Thus, in the case where the motion sensor is an attitude heading reference system, AHRS, the target location information can switch between absolute locations (GNSS data available) or relative locations (GNSS data not available).

It is to be noted that, if the inertial navigation system is not hybridized with any speed sensor, it will undergo a drift during the displacements of the module. In such a case, it is preferable to regularly recalibrate the module. It is also possible to perform regular Zero-Velocity Updates (ZUPT).

The target location information can hence be absolute or relative and can hence correspond to one or several of: the target location coordinates, the target-module distance, the module location coordinates, the target heading. This or these piece(s) of information are provided to the operator on a viewer or display screen 2 that moreover allows viewing the scene with the target, the line of sight being shown as a crosshair, one or the useful pieces of information, including the location, the heading, the distance as well as the coordinates of the target for a module including a satellite geolocation receiver, GNSS, or GPS, and a rangefinder.

This information is provided to the operator directly on the module or remotely by wired or wireless connection, for example on a “connected” viewfinder, which allows the operator to view at the same time the scene, the target, the line of sight (crosshair), and the location, heading, distance and coordinates of the target.

In an alternative embodiment, the rangefinder 9 that is of the laser type further allows providing the relative speed of the target.

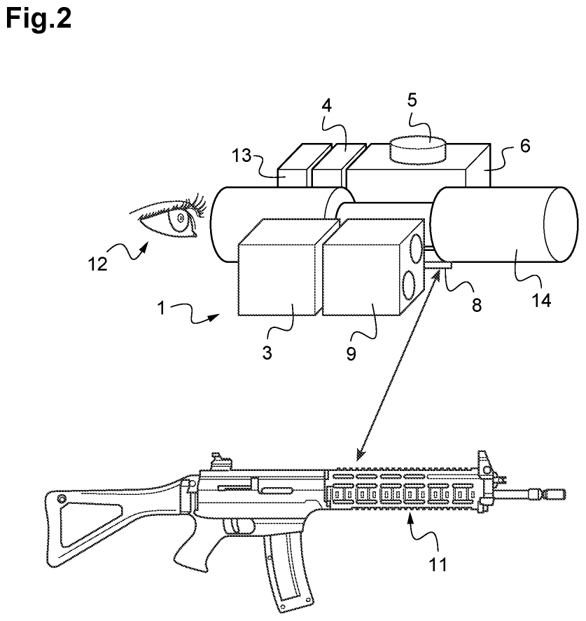

In an alternative embodiment shown in FIG. 2, a direct optical viewfinder 14 allows the operator 12 to view the target and its environment in daylight. A crosshair allows defining a reference line of sight of the target in the field of observation of the viewfinder 14. The inertial navigation system 6 hybridized with a geolocation receiver 5, for example of the GPS type, allows the calculator 4 to permanently calculate the module location and the target heading. In this case where there is no camera, the remotely provided information includes no image of the target, the target being only visible live on the module by means of the direct optical viewfinder 14. It can be planed to provide the information calculated by the calculator in the direct optical viewfinder using a direct display system, for example a liquid-crystal display, or by injection using a light information injection prism or plate through which the target can be seen. As hereinabove, the module 1 of FIG. 2 includes an attachment device compatible with a Picatinny rail for a quick and accurate mounting of the module on portable equipment that is here an assault rifle 11.

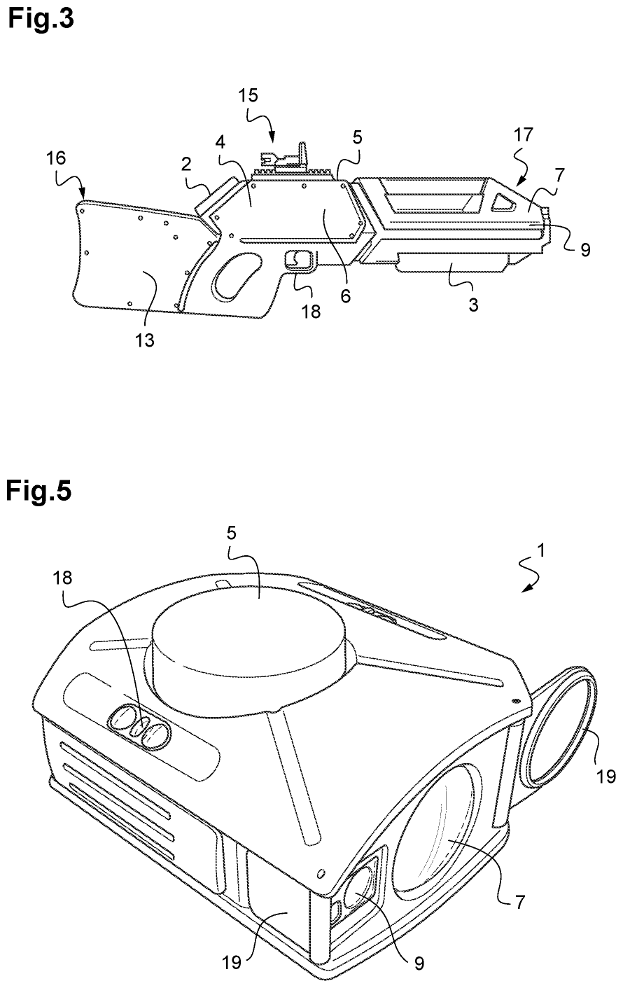

In still another alternative embodiment shown in FIG. 3, the module has been incorporated into equipment imitating a weapon and that serves only to point a target and to obtain target location information. It can even be considered that the module itself a weapon imitation. In this latter case, the module does not necessarily need a device for attachment to equipment. The pointing module can hence take the form of an assault rifle as in FIG. 3, or a handgun, or a viewfinder, integrating in particular the inertial and viewing modules.

The assault rifle module 15 of FIG. 3 includes a rear part 16 adapted to be raised on a shoulder and a front part 17. The elements constituting the assault rifle module 15 of FIG. 3 are distributed therein in such a way as to balance it. Thus, the battery 3 that supplies the module so as to make it energetically self-sufficient is arranged towards the front 17 at the lower part. The infrared camera 7 that allows viewing the target and its environment both in daylight and by night is arranged towards the front 17 at the upper part. If a laser rangefinder 9 is installed as in this example, it is also towards the front 17 and at the upper part of the module 15.

A crosshair makes it possible to define a reference line of sight of the target in the field of observation of the infrared camera 7. The infrared camera 7 can be cooled or not-cooled. The infrared camera 7 can allow an observation in the SWIR, MWIR and/or LWIR bands. The navigation system hybridized with a GPS receiver allows permanently calculating the operator location and the target heading.

The assault rifle module 15 also includes a satellite geolocation receiver 5, herein GNSS, arranged in an intermediate position along the module and upwards. The inertial navigation system 6 is also arranged in an intermediate position along the module. A radiocommunication module 13, for example Wi-Fi®, is also installed in the module, as well as the calculator 4 that allows controlling all the elements of the module, calculating the information based on the data produced by the different sensors and interfacing with the user. For the interfacing, it is in particular provided a viewer or a display screen 2 for displaying the information calculated and/or simply acquired by the sensors, as well as a trigger 18, intended for example to trigger information acquisitions and calculations when the operator has the target in sight and wants to obtain the desired information about it. As an alternative, the trigger 18 can for example serve to start the module for the target acquisition and to stop it, or to simply start it if an automatic shutdown is provided. The acquisitions and calculations on demand make it possible to reduce the power consumption of the module.

It is to be noted that, as long as the module has to be usable for target pointing, it is necessary that certain elements of the module continue to operate, and notably the inertial navigation system, in particular if doubt exists about the availability of the satellite geolocation receiver.

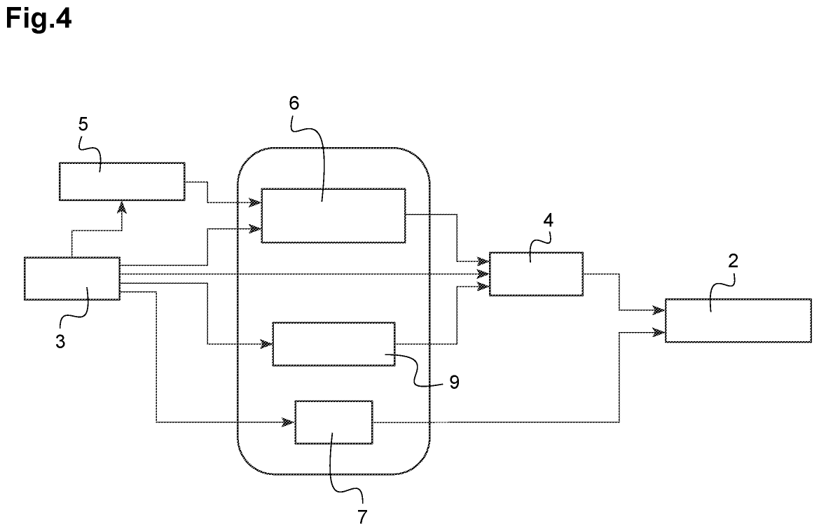

The main elements of the module are schematically illustrated in FIG. 4, in which it can be seen that the battery 3 powers the satellite geolocation receiver 5, the inertial navigation system, INS, 6, the laser rangefinder 9, the camera 7, the calculator 4 and the display screen by means of the camera 7 that sends it current in addition to the image data. The inertial navigation system, INS, 6, the laser rangefinder 9 and the camera 7 are grouped within an opto-mechanical harmonization area schematically illustrated by a boxed area in this FIG. 4. The data of the satellite geolocation receiver 5 are combined to those of the inertial navigation system 6, then sent to the calculator 4. The calculator also receives data from the laser rangefinder 9. It is understood that the module can be configured differently as regards data exchanges: the calculator can receive directly and separately the data from the satellite geolocation receiver 5, the inertial navigation system 6 and the laser rangefinder 9 and ensure the hybridization.

In FIG. 5, the module 1 is this time in the form of a viewfinder that can be attached to a rifle or another portable piece of equipment. At the upper part of the module 1 is arranged the satellite geolocation receiver 5, GNSS. At the front of the module 1, the optical elements are visible with the infrared camera 7 and the laser rangefinder 9 because their respective removable protective covers 19 have been open. To trigger the measurements and the provision of information about the aimed-at target location, a control button 18 is accessible on the module 1.

Thus, it has been seen that it is possible to make the module in various ways and that the elements that compose it can be chosen as a function of the needs. Preferably, modules with INS are made in order to benefit from the advantages of the inertial system but, in other versions, it is possible to only use an attitude heading reference system, AHRS, instead of the INS.

1. An autonomous visual pointing module (1) producing location information about a target aimed at by a user and intended to be installed on portable equipment (11) to form a portable and autonomous visual target pointing system, the target location information being at least the target heading, the module including:
an autonomous power supply (3),
control, calculation and user-interfacing electronic circuits (4),
a motion sensor including an inertial navigation system, INS, (6) providing the module location and heading, or an attitude heading reference system, AHRS, providing only the heading,
a satellite geolocation receiver, GNSS, (5) for providing the module location in real time and continuously, and for hybridizing the inertial sensors,
an optronic unit including a set of optical sensors of the viewfinder (14) and/or camera (7) type, for visually pointing the module to the aimed-at target, and a rangefinder (9) for determining the distance between the target and the module,
wherein the motion sensor includes gyrometers and accelerometers, and wherein the gyrometers are of the fibre-optic, FOG, or ring-laser, RLG, or hemispherical-resonator, HRG, type, making it possible to autonomously determine the North direction.

2. The module (1) according to claim 1, further comprising a pedometer and wherein the inertial navigation system, INS, or the attitude heading reference system, AHRS, is further hybridized with the pedometer.

3. The module (1) according to claim 2, further comprising an attachment device (8) for attaching the module to the portable equipment (11) and wherein the attachment device is configured to be attached to an attachment rail of the equipment.

4. The module (1) according to claim 3, further comprising a user direct-sight optical viewfinder and at least one target viewing camera producing images, said at least one camera allowing a viewing of the target at least in daylight.

5. The module (1) according to claim 4, wherein said at least one camera (7) further allows a viewing of the target by night.

6. The module (1) according to claim 5, wherein the module includes:
either two cameras, a first one for viewing the target in daylight and a second one for viewing the target by night, the second camera being chosen among the light-intensifying camera or the only infrared-sensitive cameras,
or a single camera for viewing the target in daylight combined with a target illuminator for lighting the target by night in order to allow its viewing,
or a single, only infrared-sensitive camera for viewing the target both in daylight and by night.

7. The module (1) according to claim 1, further comprising at least one camera (7) producing images of the aimed-at target and at least one viewer (2) for displaying said images, said at least one viewer being integrated to the module and/or arranged remote from the module.

8. The module (1) according to claim 4, further comprising a wireless data communication device (13) for transmitting the target location information and the images of the aimed-at target in the case where the module includes at least one camera (7).

9. The module (1) according to claim 1, wherein the module has a level of uncertainty that is lower than or equal to 2 mrad rms for the heading and a level of accuracy for the location corresponding to that of the satellite geolocation receiver, GNSS, (5).

10. The module (1) according to claim 1, wherein the module has a weight lower than five kilograms.

11. A system consisted of an autonomous visual pointing module (1) attached to portable equipment (11), wherein the module is configured according to claim 1 and the portable equipment (11) is a portable weapon, said weapon being intended to at least remotely neutralize a targeted objective.

12. The module (1) according to claim 6, further comprising at least one camera (7) producing images of the aimed-at target and at least one viewer (2) for displaying said images, said at least one viewer being integrated to the module and/or arranged remote from the module.

13. The module (1) according to claim 12, further comprising a wireless data communication device (13) for transmitting the target location information and the images of the aimed-at target in the case where the module includes at least one camera (7).

14. The module (1) according to claim 13, wherein the module has a level of uncertainty that is lower than or equal to 2 mrad rms for the heading and a level of accuracy for the location corresponding to that of the satellite geolocation receiver, GNSS, (5).

15. The module (1) according to claim 14, wherein the module has a weight lower than five kilograms.

16. The module (1) according to claim 1, further comprising has fibre-optic gyrometers with coils diameters of 50 mm or less.

17. The module (1) according to claim 15, further comprising has fibre-optic gyrometers with coils diameters of 50 mm or less.

18. The module (1) according to claim 1, further comprising an attachment device (8) for attaching the module to the portable equipment (11) and wherein the attachment device is configured to be attached to an attachment rail of the equipment.

19. The module (1) according to claim 1, further comprising a user direct-sight optical viewfinder and at least one target viewing camera producing images, said at least one camera allowing a viewing of the target at least in daylight.

20. The module (1) according to claim 2, further comprising a user direct-sight optical viewfinder and at least one target viewing camera producing images, said at least one camera allowing a viewing of the target at least in daylight.
